(19) United States
(12) Patent Application Publication
(10) Pub. No.: US 2014/0047153 A1
(43) Pub. Date: Feb. 13, 2014

(54) COMPUTING APPARATUS WITH ENHANCED PARALLEL I/O FEATURES

(71) Applicant: Samsung Electronics Co., Ltd., Suwon-si (KR)

(72) Inventors: Myung-June JUNG, Suwon-si (KR); Ju-Pyung LEE, Suwon-si (KR)

(73) Assignee: Samsung Electronics Co., Ltd., Suwon-si (KR)

(21) Appl. No.: 13/959,990

(22) Filed: Aug. 6, 2013

(30) Foreign Application Priority Data
Aug. 7, 2012 (KR) 10-2012-0086372

(51) Int. Cl. G06F 13/42

(52) U.S. Cl. CPC G06F 13/4221
USPC 710/306

(57) ABSTRACT

Provided is a parallel I/O computing apparatus that includes a plurality of computing devices that may have different response characteristics depending on a number of parallel I/Os that are processed by the computing devices. The computing apparatus also includes an I/O dispatcher that distributes a different number of I/Os to one or more of the computing devices based on characteristics of the computing devices.

### CROSS-REFERENCE TO RELATED APPLICATION(S)

This application claims the benefit under 35 USC §119(a) of a Korean Patent Application No. 10-2012-0086372, filed on Aug. 7, 2012, in the Korean Intellectual Property Office, the entire disclosure of which is incorporated herein by reference for all purposes.

### BACKGROUND

1. Field

The following description relates to a technology for parallel input and output (I/O) by a computing apparatus.

2. Description of the Related Art

Parallelism allows computers to perform multiple operations at the same time. An example of parallelism is in input and output between computing apparatuses such as a processor and an intelligent storage. For a multi-core processor, for example, as the number of processor cores increases, interfaces that have peripheral devices such as a memory, and the like, are increasingly being parallelized.

A storage device such as a solid-state disk (SSD) may improve its speed with parallel input and output (I/O). In an environment in which a plurality of solid-state disks are connected to an external device for parallel I/O, each solid-state disk is typically connected such that is has the same degree of parallelism. However, solid-state disks have different features, and thus, this same connection is not optimized in performance.

US Patent Application Publication No. 2011/0072208, published on Mar. 24, 2011, describes a technology for monitoring performance characteristics and workloads of distributed storage resources, calculating load metrics, and performing load balancing between the distributed storage resources. However, this reference does not take into account the distribution of a degree of parallelism.

### SUMMARY

In an aspect, there is provided a parallel input/output (I/O) computing apparatus including a plurality of computing devices that comprise different response characteristics based on a number of parallel I/Os processed by the plurality of computing devices, and an I/O dispatcher connected to the computing devices and configured to distribute a different number of parallel I/Os to at least one of the computing devices based on characteristics of the plurality of computing devices.

The plurality of computing devices may comprise a plurality of solid-state disks.

The I/O dispatcher may be further configured to redirect I/O traffic from an external device to the plurality of computing devices based on a mapping table that stores a parallel I/O dispatch for optimizing an overall parallel I/O performance.

The I/O dispatcher may comprise an information collector configured to collect information about characteristics of the plurality of computing devices, and an adaptive dispatcher configured to allocate the parallel I/Os to the plurality of computing devices based on the collected characteristic information about the plurality of computing devices.

The information collector may comprise a response characteristic information collector configured to collect response characteristic information that varies based on the number of parallel I/Os performed by each of the plurality of computing devices.

The adaptive dispatcher may comprise an optimal-dispatch calculator configured to calculate a parallel I/O dispatch for optimizing overall parallel I/O performance using response characteristics that vary depending on the number of parallel I/Os of each of the plurality of computing devices, and to store the calculated parallel I/O dispatch in a mapping table, and an I/O distribution part for redirecting I/O traffic from the external device according to the stored mapping table.

The information collector may further comprise a state information collector configured to collect state information of each of the plurality of computing devices, and the adaptive dispatcher may further comprise an optimal-dispatch selector configured to select one of a plurality of optimal values calculated by the optimal-dispatch calculator based on the state information about the one of the computing devices, and to store the optimal value in the mapping table.

In an aspect, there is provided a computing apparatus, including a first computing device configured to process I/O requests and comprising a first processing characteristic, a second computing device configured to process the I/O requests and comprising a second processing characteristic that is different from the first processing characteristic of the first computing device, and an allocator configured to allocate a different amount of I/O requests to the first and second computing devices, respectively, based on the difference in the first and second processing characteristics.

The first and second processing characteristics may be based on a number of I/O requests processed by the first and second computing devices, respectively, over a predetermined amount of time.

The first and second processing characteristics may be based on a latency between an input of an I/O request and an output of the I/O request at the first and second computing devices, respectively.

The first and second computing devices may comprise solid-state disk (SSD) drives.

The dispatcher may be configured to detect a change in at least one of the first processing characteristic of the first computing device and the second processing characteristic of the second processing device, and to redirect the I/O requests to the first and second computing devices based on the detected change.

The computing apparatus may further comprise a storage configured to store a table that stores information about the first and second processing characteristics, and the dispatcher may allocate the I/O requests based on the information stored in the table.

Other features and aspects will be apparent from the following detailed description, the drawings, and the claims.

### BRIEF DESCRIPTION OF THE DRAWINGS

FIG. 1 is a diagram illustrating an example of a computing apparatus.

FIG. 2 is a diagram illustrating an example of an I/O dispatcher of FIG. 1.

FIGS. 3 to 5 are graphs illustrating examples of performance characteristics of a solid-state disk.

FIG. 6 is a graph illustrating an example of a change in a basis function depending on an input variable.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

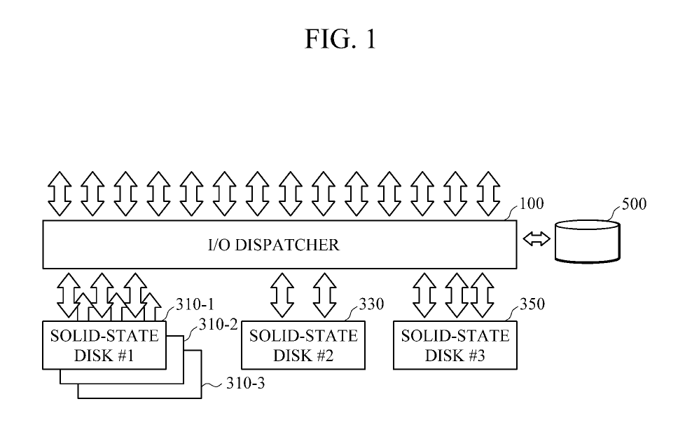

FIG. 1 illustrates an example of a computing apparatus. For example, the computing apparatus may be a terminal such as a computer, a phone, a tablet, an appliance, and the like.

Referring to FIG. 1, the parallel I/O computing apparatus includes a plurality of computing devices 310, 330, 350, and 370 that may have a different response characteristic based on the number of parallel I/Os and an I/O dispatcher 100 connected to the computing devices 310, 330, 350, and 370. The parallel I/O computing apparatus is configured to distribute parallel I/O requests to the plurality of computing devices and process the parallel I/O requests. According to various aspects, a different number of parallel I/Os may be allocated to one or more of the computing devices based on characteristics of the computing devices.

According to various aspects, the computing devices may be solid-state disks (SSDs). For example, the I/O dispatcher 100 may connect the solid-state disks to each core of a multi-core processor, a portion of I/O addresses of a single core, or a group of cores.

It should be appreciated that the description herein is not limited thereto, but may be considered to cover all computing devices that support parallel I/O. For example, the I/O dispatcher 100 may have a configuration for establishing an intelligent sensing network with the cores of the multi-core processor.

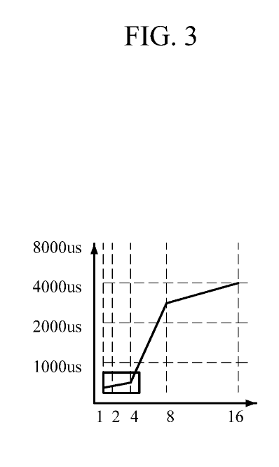

One or more of the plurality of computing devices 310, 330, 350, and 370 may have different response characteristics based on the number of parallel I/Os For example, the response characteristic may be a performance characteristic index such as latency, and I/O operations per second (IOPS). As an example, the computing devices 310-1 to 310-3 may be solid-state disks that have the same latency characteristic with respect to the degree of parallelism as in FIG. 3. In this example, the three solid-state disks 310-1 to 310-3 that have the same characteristic may be allocated the same degree of parallelism. As shown in FIG. 3, latency characteristics of these solid-state disks may be maintained until the degree of parallelism is 4, and rapidly deteriorates when the degree of parallelism is 5 or above.

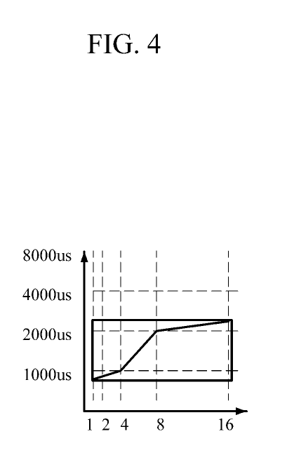

Computing device 330 may be a solid-state disk that has the same latency characteristic with respect to the degree of parallelism as in FIG. 4. In this example, the solid-state disk 330 has a response characteristic that is better than the solid-state disk 310 when the degree of parallelism is high, and a worse response characteristic than the solid-state disk 310 when the degree of parallelism is low.

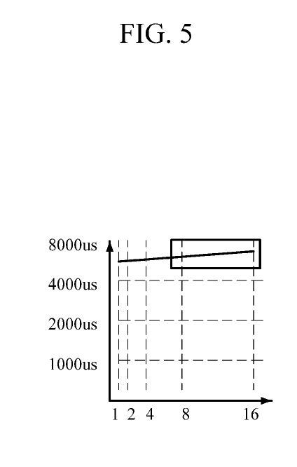

Computing device 350 may be a solid-state disk that has the same latency characteristic with respect to the degree of parallelism as in FIG. 5. In this example, the solid-state disk has a latency characteristic that is bad when the degree of parallelism is low, and it also has a bad latency characteristic even when the degree of parallelism becomes higher.

For a specific solid-state disk, the higher the degree of parallelism is, the better its latency characteristic is. For example, such a latency characteristic may imply the existence of a special I/O processing engine that is activated by internally responding to the degree of parallelism. For example, the characteristic difference between the solid-state disks may be caused by the difference in a structure of an internal intelligent controller, a flash translation layer (FTL) for managing a NAND flash memory, and the like.

In the following table, an example of a latency characteristic, i.e. (μsec) in this description, of the solid-state disks is summarized.

TABLE 1

| Degree of Parallelism | SSD A | SSD B | SSD C |
|---|---|---|---|
| 1 | 290 | 750 | 6,000 |
| 2 | 290 | 800 | 6,100 |
| 4 | 300 | 1,000 | 6,200 |
| 8 | 3,000 | 2,000 | 6,300 |
| 16 | 4,000 | 2,500 | 6,400 |

According to various aspects, the I/O dispatcher 100 may redirect I/O traffic received from an external device according to the table storing a parallel I/O dispatch in order to further optimize performance in all parallel I/Os. The optimized parallel I/O dispatch may be calculated by a separate device and then input to and stored as the mapping table in the storage device 500 shown in FIG. 1. An example of a method of calculating the optimized parallel I/O dispatch is further described below.

The I/O dispatcher 100 may distribute parallel I/O requests with reference to the mapping table. As a non-limiting example only, in FIG. 1, among 14 parallel I/Os received from the outside, nine parallel I/Os may be allocated to the three solid-state disks 310-1 to 310-3 three by three, two parallel I/Os may be allocated to the solid-state disk 330, and three parallel I/Os may be allocated to the solid-state disk 350. In conventional art, parallel I/O requests are allocated equally irrespective of characteristics of the solid-state disks. In contrast, according to various aspects herein, the optimal parallel I/O allocation may be accomplished based on the characteristics of the computing devices such as the solid-state disks shown in FIG. 1.

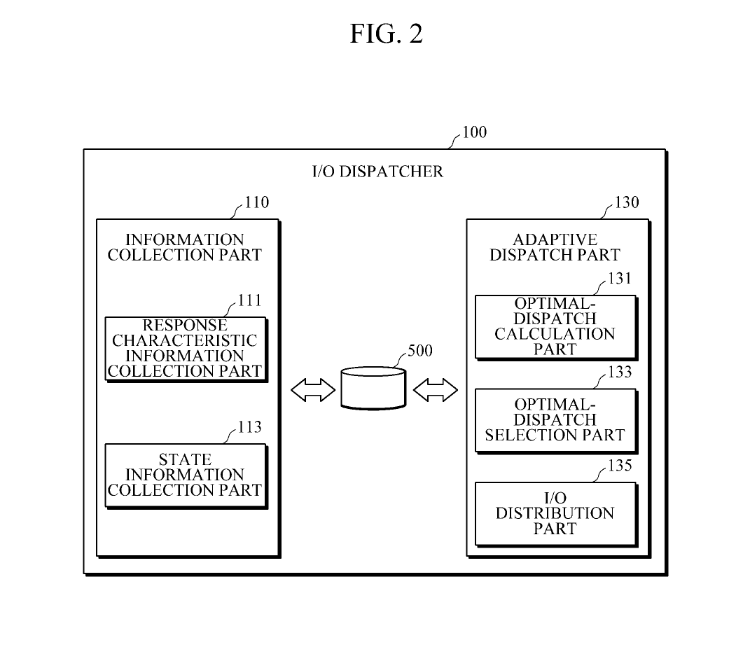

FIG. 2 illustrates an example of an I/O dispatcher of FIG. 1. Referring to FIG. 1, the I/O dispatcher 100 includes an information collection part 110 for collecting information about characteristics of the computing devices and an adaptive dispatch part 130 for allocating parallel I/Os based on the collected characteristic information about the computing devices.

In this example, the information collection part 110 includes a response characteristic information collection part 111 for collecting response characteristic information that varies depending on the number of parallel I/Os processed by each of the connected solid-state disks. For example, the latency refers to a time delay between a time point when data is requested to the computing device and a time point when the data is available to an output port. As another example, TOPS refers to the number of I/O commands processed per second.

The adaptive dispatch part 130 includes an optimal-dispatch calculation part 131 for calculating parallel I/O dispatch that may be used to optimize performance in the parallel I/Os and for storing the calculated parallel I/O dispatch in the mapping table included in the storage device 500 using a response characteristic that varies depending on the number of parallel I/Os of each of the connected solid-state disks. The adaptive dispatch part 130 also includes an I/O distribution part 135 for redirecting I/O traffic from an external device based on the stored mapping table.

For example, the parallel I/O dispatch refers to information about the number of I/Os processed by each computing device that is connected to the I/O dispatcher 100. The I/O distribution part 135 redirects the parallel I/O requests received from the external devices through respective predetermined parallel I/O paths to the computing devices.

Based on the performance characteristic information about the computing devices and based on an entire load of the system, that is, the number of parallel I/Os, the system may individually determine the number of parallel I/Os that are delivered to each of the computing devices, thereby improving the performance of the system. To this end, a basis function may be used to measure a degree of enhancement or degradation of performance due to adaptive I/O handling. However, it is difficult to accurately measure the degree of enhancement of performance due to adaptive I/O handling only using latency values for the computing devices. According to various aspects, an aggregated TOPS that is calculated from the latency values of the computing devices may be used as an optimization basis function. For example, the basis function or objective function may be expressed as follows:

$$Basis function = {\sum }_{i = 1}^{N} \frac{1}{{Lat}_{i} ( {Nio}_{i} )} ,$$

where Nio_i is the number of parallel I/Os that are delivered to i-th computing device, Lat_i(Nio_i) is a latency of the i-th computing device when Nio_i number of parallel I/Os are applied, and

$$\frac{1}{{Lat}_{i} ( {Nio}_{i} )} ,$$

the reciprocal of Lat_i(Nio_i), is an TOPS for the i-th computing device.

For example, as shown in FIG. 1, if 4 parallel I/Os are dispatched in the solid-state disk 310, 8 parallel I/Os are dispatched in the solid-state disk 330, and 12 parallel I/Os are dispatched in the solid-state disk 350, a value of the basis function may be calculated as follows:

$$\begin{matrix}{\sum }_{i = 1}^{N} \frac{1}{{Lat}_{i} ( {Nio}_{i} )} = \frac{1}{300 us / io} + \frac{1}{2 , 000 us / io} + \frac{1}{6 , 350 us / io} \\ = 3 , 333 IOPS + 500 IOPS + 157 IOPS \\ = 3 , 990 IOPS\end{matrix}$$

Here, the optimized I/O dispatch value for maximizing the basis function may be expressed as follows:

$$Nio = \{ {Nio}_{1} , {Nio}_{2} , … , {Nio}_{N} \text{:} maximizing {\sum }_{i = 1}^{N} \frac{1}{{Lat}_{i} ( {Nio}_{i} )} \}$$

Herein, it can be seen that there are limitations between variables as follows:

Nio₁+Nio₂+Nio₃=24

Nio₁, Nio₂, Nio₃∈Z

Nio₁≧0, Nio₂≧0, Nio₃≧0

To further reduce an amount of calculation, assuming Nioᵢ is one of 0, 1, 2, 4, 8, 16, a possible I/O dispatch combination is as follows:

| Nio₁ | Nio₂ | Nio₃ |
|---|---|---|
| (for SSD A) | (for SSD B) | (for SSD C) |
| 4 | 4 | 16 |
| 4 | 16 | 4 |
| 8 | 8 | 8 |
| 8 | 16 | 0 |
| 16 | 4 | 4 |
| 16 | 8 | 0 |

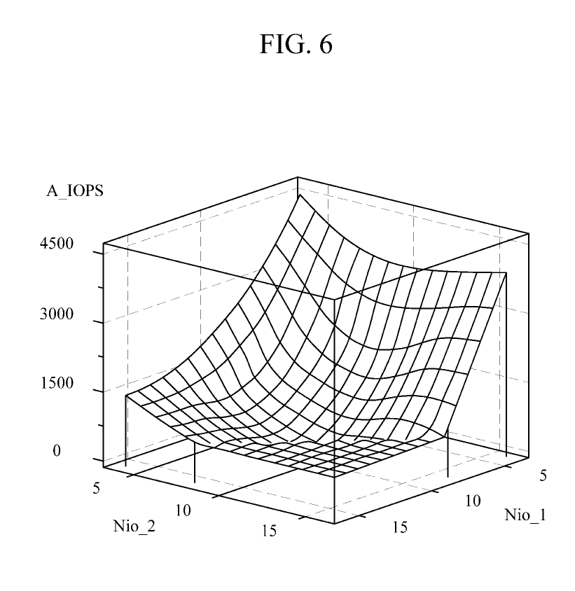

In this example, the aggregated IOPS may be expressed as a function of Nio₁ and Nio₂ because the sum of Nioᵢ values is constant as 24, that is, the number of parallel I/Os requested from the outside is constant. The distribution of the aggregated IOPS is shown in FIG. 6.

From this graph and from the calculation result for all possible combinations, in this example, it can be seen that a maximum IOPS may be accomplished if Nio₁=4, Nio₂=4, and Nio₃=16.

The performance characteristic such as latency of solid-state disks or computing devices may frequently vary based on a use condition or environment. According to various aspects, the response characteristic information collection part 111 may collect response characteristic information that varies depending on the number of parallel I/Os of each solid-state disk connected to the I/O distribution part 135. Accordingly, the optimal-dispatch calculation part 131 may calculate the optimal I/O dispatch with reference to the collected performance characteristic information. In this example, the optimal I/O dispatch may be calculated by finding the maximum of a two-variable function. Here, it becomes more complicated to find the maximum of a two-variable function as the number of connected computing devices increases. To solve this problem, a well-known numerical method may be used.

According to various aspects, the information collection part 110 may further include a state information collection part 113 for collecting state information about the connected solid-state disk, and the adaptive dispatch part 130 may further include an optimal-dispatch selection part 133 for selecting one of a plurality of optimal values based on the state information collected about the solid-state disk and for storing the optimal value in the mapping table when the optimal-dispatch calculation part 131 calculates the plurality of optimal values for the parallel I/O dispatch.

That is, if a plurality of I/O dispatches are received, the optimal I/O dispatch may be determined in consideration with another variable in addition to performance variables such as latency. For example, for a solid-state disk, a wear-out degree for each solid-state disk, a network traffic state, and the like, may be considered. Considering another variation in performance that varies depending on the degree of parallelism, more optimized I/O dispatch may be accomplished. For example, the optimal-dispatch selection part 133 may calculate a performance function for I/O dispatch combinations output from the optimal-dispatch calculation part 131 and output the I/O dispatch for maximizing the performance function.

According to various aspects, optimal parallel I/O dispatch can be accomplished in computing apparatuses that support parallel I/O, and in particular, various types of computing apparatuses. An objective function may be given as a function of a response characteristic such as latency and IO operation per second (IOPS), and the parallel I/O dispatch for accomplishing the optimal response characteristic may be calculated. This I/O dispatch allocation may be calculated with a mathematical optimization algorithm.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A parallel input/output (I/O) computing apparatus comprising:
a plurality of computing devices that comprise different response characteristics based on a number of parallel I/Os processed by the plurality of computing devices; and
an I/O dispatcher connected to the computing devices and configured to distribute a different number of parallel I/Os to at least one of the computing devices based on characteristics of the plurality of computing devices.

2. The parallel I/O computing apparatus of claim 1, wherein the plurality of computing devices comprise a plurality of solid-state disks.

3. The parallel I/O computing apparatus of claim 1, wherein the I/O dispatcher is further configured to redirect I/O traffic from an external device to the plurality of computing devices based on a mapping table that stores a parallel I/O dispatch for optimizing an overall parallel I/O performance.

4. The parallel I/O computing apparatus of claim 1, wherein the I/O dispatcher comprises:
an information collector configured to collect information about characteristics of the plurality of computing devices; and
an adaptive dispatcher configured to allocate the parallel I/Os to the plurality of computing devices based on the collected characteristic information about the plurality of computing devices.

5. The parallel I/O computing apparatus of claim 4, wherein the information collector comprises a response characteristic information collector configured to collect response characteristic information that varies based on the number of parallel I/Os performed by each of the plurality of computing devices.

6. The parallel I/O computing apparatus of claim 5, wherein the adaptive dispatcher comprises:
an optimal-dispatch calculator configured to calculate a parallel I/O dispatch for optimizing overall parallel I/O performance using response characteristics that vary depending on the number of parallel I/Os of each of the plurality of computing devices, and to store the calculated parallel I/O dispatch in a mapping table; and
an I/O distribution part for redirecting I/O traffic from the external device according to the stored mapping table.

7. The parallel I/O computing apparatus of claim 6, wherein the information collector further comprises a state information collector configured to collect state information of each of the plurality of computing devices, and
the adaptive dispatcher further comprises an optimal-dispatch selector configured to select one of a plurality of optimal values calculated by the optimal-dispatch calculator based on the state information about the one of the computing devices, and to store the optimal value in the mapping table.

8. A computing apparatus, comprising:
a first computing device configured to process I/O requests and comprising a first processing characteristic;
a second computing device configured to process the I/O requests and comprising a second processing characteristic that is different from the first processing characteristic of the first computing device; and
an allocator configured to allocate a different amount of I/O requests to the first and second computing devices, respectively, based on the difference in the first and second processing characteristics.

9. The computing apparatus of claim 8, wherein the first and second processing characteristics are based on a number of I/O requests processed by the first and second computing devices, respectively, over a predetermined amount of time.

10. The computing apparatus of claim 8, wherein the first and second processing characteristics are based on a latency between an input of an I/O request and an output of the I/O request at the first and second computing devices, respectively.

11. The computing apparatus of claim 8, wherein the first and second computing devices comprise solid-state disk (SSD) drives.

12. The computing apparatus of claim 8, wherein the dispatcher is configured to detect a change in at least one of the first processing characteristic of the first computing device and the second processing characteristic of the second processing device, and to redirect the I/O requests to the first and second computing devices based on the detected change.

13. The computing apparatus of claim 8, further comprising a storage configured to store a table that stores information about the first and second processing characteristics,
wherein the dispatcher allocates the I/O requests based on the information stored in the table.
